(19) United States
(12) Patent Application Publication
(10) Pub. No.: US 2011/0067224 A1
(43) Pub. Date: Mar. 24, 2011

(54) FASTENING SYSTEM WITH FABRIC LAYERS

(76) Inventors: Ulrich Knebel, Bad Berleburg-Berghausen (DE); Joachim Tiemann, Sundern (DE)

(21) Appl. No.: 12/885,807

(22) Filed: Sep. 20, 2010

(30) Foreign Application Priority Data
Sep. 18, 2009 (DE) 10 2009 029 597.6

(51) Int. Cl. B23P 11/00; B23P 23/04

(52) U.S. Cl. 29/525.01; 29/33 R

(57) ABSTRACT

The present invention relates to a fastening system for deepened mounting of a dowel comprising a compressable insulation material, a dowel with a pressing plate, a first fabric layer to be applied to the underside of the pressing plate, as well as a second fabric layer for creating a fabric overlapping with the first fabric layer, and a respective mounting method.

The present invention relates to a method and a fastening system for deepened mounting of insulation panels by using an insulation dowel together with fabric layers, in particular in form of reinforcement mats.

A thermal insulation system which is used for mounting insulation panels made of mineral wool which uses dowels with holding plates is known from DE 102 47 457 A1. Here, the dowels are used in the sense of an aid for improving the transverse tensile strength of the insulation panels, such that obviously a reduced number of dowels may be applied. This reduced number of dowels would not be able to support the thermal insulation system without consideration of the holding effect of the adhesive mortar against wind suction forces; rather a pulling-through of the dowel plate through the material of the insulation panels would occur, such that the insulation panels would fall down together with the exterior plaster. In their function as aid for improving the overall resulting transverse tensile strength of the insulation panels, rather a basic strength against wind suction loads through the adhesive connection of the adhesive mortar occurs and a safeguard against exfoliation respectively lifting-off of the upper layers of the insulation panels under the wind suction forces through the reduced number of dowels. At the position of the dowel plates an immediate safeguarding of the material of the insulation panels against wind suction force occurs, however, in the area between the dowels, the dowels contribute, through anchoring of the surface areas of the insulation panels through surface sided tensile forces in the direction of the dowels, to an improvement of the overall resulting transverse tensile strength. Thereby, obviously a similar effect is achieved as with the holding down of a surface by means of a quilt at multiple quilt buttons as compared to a homogeneous feather-bed which under suction forces would be exposed to significantly larger surface deformations.

In DE 197 04 112 generally an insulating wall cladding is described with carrier elements fastened perpendicularly at an exterior wall with spacings. The carrier element consists of an insulation material strip and a carrier strip and is mounted at the wall by means of a dowel. Preferably, between the wall and the insulation material strip as well as between the insulation material strip and the carrier strip, an adhesive layer is applied. The carrier strip is provided with a metal sheet in order to improve the strength. Screws may be applied through the metal sheet from the outside which are securely held within this metal sheet. For the insulation material strip preferably mineral fiber material is used. For the carrier strip organic and/or inorganic material as for example plate material of calcium silicate or of cement bounded material is used. In this way, thermal bridges shall be avoided as far as possible and a simple, safe and cost efficient mounting of the sub-construction and of the superstructures to be fastened thereto shall be achieved.

The doweling of two or multi layer mineral insulation panels is from today's point of view in the deepened application—where the pressing plate regularly pulls into the insulation material surface under deformation of the latter—in principle possible; however, it has so far only been realized with extremely low system loads and has therefore been regarded as insufficient. It is therefore the object of the present invention to provide a method respectively a thermal insulation system, which overcomes the disadvantages of the known solutions in a simple and cost efficient manner. The object is solved according to the invention by a method for deepened mounting of a dowel, in an insulation material, wherein the dowel comprises a pressing plate and a dowel sleeve attached thereto as well as a spreading element, wherein the method comprises the steps: (a) drilling of a bore hole through the insulation material and into a sub-construction, (b) cutting into the insulation material by means of a cutting device, (c) applying a first fabric layer onto the underside of the pressing plate, (d) inserting the dowel into the bore hole until it rests onto the insulation material surface, (e) driving in the spreading element by means of a mounting tool under compression of the insulation material and formation of a cylindrical recess of a predetermined depth in the insulation material, (f) reinforcing of the entire insulation material surface with a second fabric layer, such that in the vicinity of the recess a fabric overlapping occurs under cross-linking of the individual fabric layers; as well as by a fastening system for deepened mounting of a dowel comprising a compressible insulation material, a dowel with a pressing plate, a first fabric layer to be applied to the underside of the pressing plate as well as second fabric layer for creating a fabric overlapping with the first fabric layer. The method steps may, but do not have to, occur in the specified order. The object is further solved by a method for deepened mounting of a dowel in an insulation material, wherein the dowel comprises a pressing plate and a dowel sleeve attached thereto as well as a spreading element and wherein the insulation material comprises pre-fabricated cylindrical recesses for receiving the pressing plate, wherein the method comprises the following steps: (a) drilling a bore hole in a recess through the insulation material and into a sub-construction; (b) providing a first fabric layer in the area of the recess; (c) inserting the dowel through the first fabric layer into the bore hole and the recess; (d) driving in the spreading element by means of a mounting tool; (e) reinforcing the entire insulation material surface with a second fabric layer, such that in the vicinity of the recess a fabric overlapping occurs under cross-linking of the individual fabric layers, as well as by a fastening system for deepened mounting of a dowel comprising an insulation material with prefabricated cylindrical recesses; a dowel with a pressing plate; a first fabric layer to be applied to the underside of the pressing plate; as well as a second fabric layer for creating a fabric overlapping with the first fabric layer. The method steps may, but do not have to, occur in the specified order.

Hereby, respectively a deepened mounting of the dowel in the insulation material is enabled, by means of which on the one hand the formation of thermal bridges may practically be eliminated. At the same time, on the other hand, the dowel is embedded into the system such that significantly higher forces as so far may be introduced into the dowel and thus a dowel load may be achieved, which may also resist extreme weather conditions (for example strong wind suction) in a cost efficient manner.

In a preferred embodiment of the invention after step (e) respectively step (d) the cylindrical recess is closed with a corresponding circular member. This may become necessary if the cylindrical recess is deeper respectively significantly deeper as the thickness of the pressing plate of the dowel and if an especially effective prevention of thermal bridges shall be achieved.

In a further preferred embodiment of the invention the first fabric layer, which is usually formed as a reinforcement mat, comprises the shape of the cylindrical recess. Hereby the mounting process for conventional pressing plate diameters and conventional mounting depths (of the pressing plates into the insulation material) is facilitated, since the danger of a slipping of the mat is eliminated. Conventional pressing plate diameters are 30, 60, 90 or 120 mm. Conventional mounting depths are 0.5, 1, 1.5 or 2 cm. Depending on the individual application, also other diameters/depths may become necessary.

In another preferred embodiment of the invention the shape of the first fabric layer is provided by means of a binder. Hereby, a sufficient strength of the predetermined shape is achieved. As binder regularly resins, synthetic resin dispersions or two-component reactive resins are used.

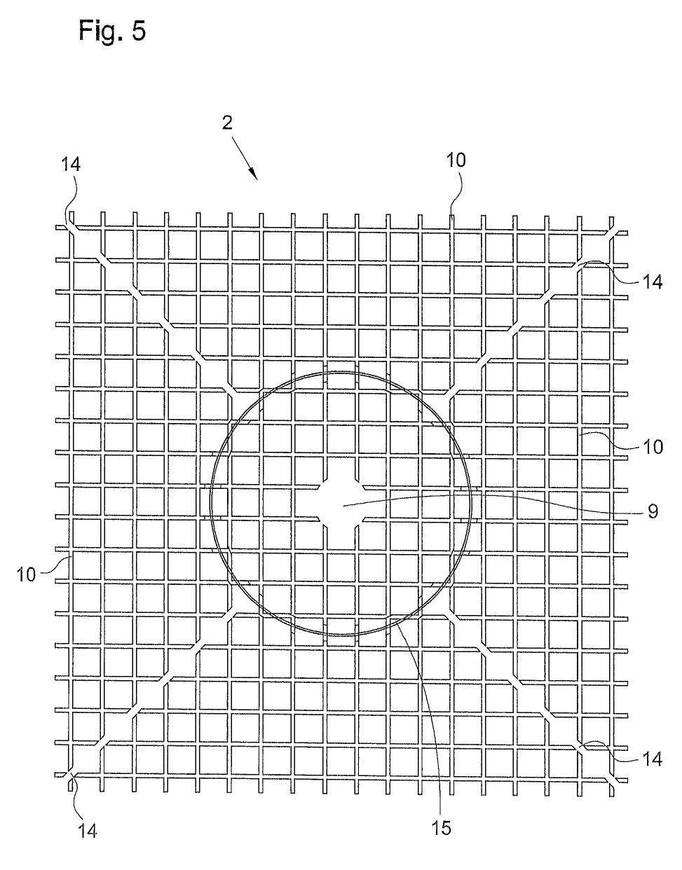

In a still further preferred embodiment of the invention the dowel may, by creating a cylindrical recess in the insulation material, be mounted in a deepened manner in the latter (respectively in the cylindrical recess which is pre-fabricated in the insulation material), such that the first fabric layer rests in the vicinity of the recess onto the upper side of the insulation material. This resting on the insulation material surface is necessary for the later cross-linking with the second fabric layer (regularly a reinforcement mat with a big surface)—and thus also for the increase of the dowel bearing capacity. The formation of folds at the fabric layers should, if possible, be avoided, in order not to impair the cross-linking (for example the fabric layer may be cut, cf. FIG. 5). The first fabric layer may, according to the requirements, vary with respect to its size and shape, such that varying system bearing capacities may be achieved. As a general rule it may be established here that the larger the ring-shaped contact surface of the first fabric layer onto the insulation material surface is, the higher is the system bearing capacity which may be achieved through the higher degree of cross-linking.

In a still further preferred embodiment of the invention the first fabric layer lies respectively rests at the inner wall of the cylindrical recess in the insulation material. This is also important for achieving a sufficient system bearing capacity since otherwise the mounting of the circular member is made more difficult and a slipping of the first fabric layer may occur.

By means of the following drawings the deepened mounting of an inventive fastening system in a mineral insulation material is illustrated.

It shows:

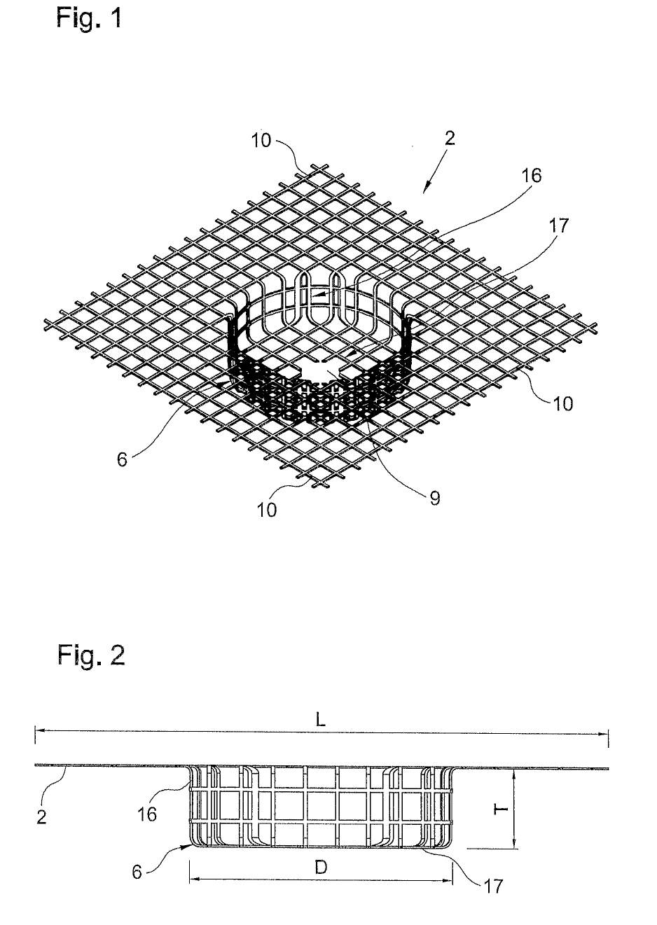

FIG. 1 a perspective view of a first embodiment of a reinforcement mat with square grid lines and with a cylindrical recess to be applied to the underside of a pressing plate;

FIG. 2 a side view of a first embodiment of a reinforcement mat according to FIG. 1;

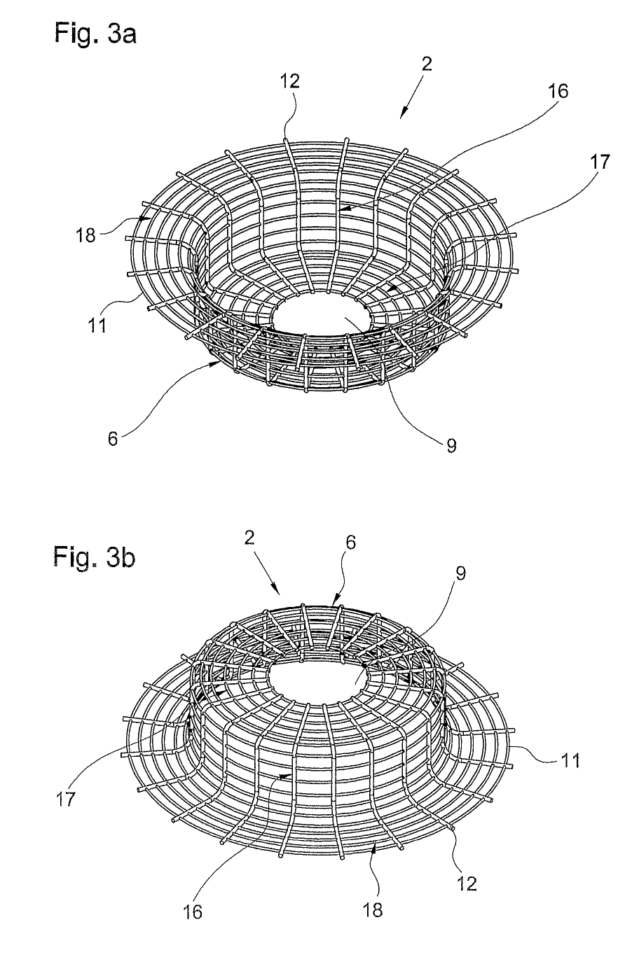

FIG. 3a a perspective view of a second embodiment of a reinforcement mat with concentric and radial grid lines and with a cylindrical recess to be applied to the underside of a pressing plate;

FIG. 3b an upside down view of a second embodiment of a first reinforcement mat according to FIG. 3;

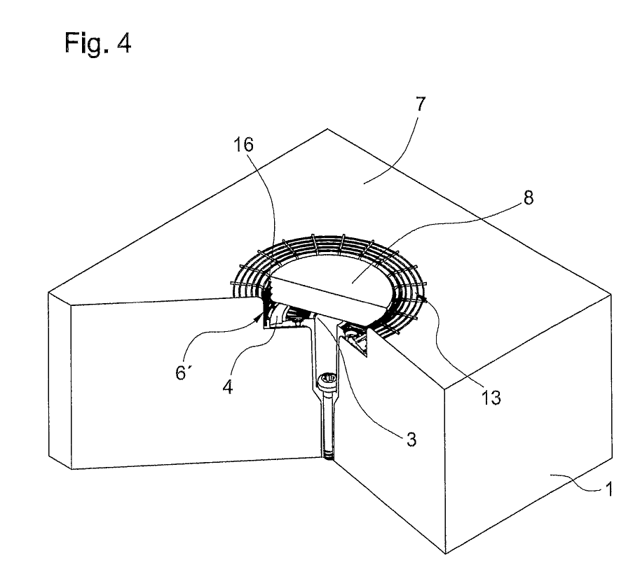

FIG. 4 a perspective cross section of a first reinforcement mat according to a second embodiment in a mounted condition;

FIG. 5 a top view onto a third embodiment of a first reinforcement mat with square grid lines and with pre-fabricated cuts for the mounting of the reinforcement mat.

In FIG. 1 a first embodiment of a first reinforcement mat respectively fabric layer 2 for use in an inventive fastening system is illustrated. The first reinforcement mat respectively fabric 2 comprises a square ground plane and consists of square grid lines 10. In the middle area of the first fabric layer 2 a cylindrical depression respectively recess 6 is arranged. The cylindrical depression respectively recess 6 is regularly pre-fabricated in order to facilitate the mounting of the inventive fastening system for conventional pressing plate diameters and conventional mounting depths. The side wall 16 of the cylindrical recess 6 regularly extends vertically downwards, such that in this area the otherwise square grid lines 10 of the first reinforcement mat respectively fabric layer 2 are somewhat pulled apart. The bottom 17 of the cylindrical depression respectively recess 6 comprises a regularly centrally arranged opening 9 through which the shaft of a dowel 3 may extend later on, in order to achieve 1 an anchorage with a sub-construction through the insulation material. The shape of the cylindrical depression respectively recess 6 corresponds to the shape of the recess which is formed during mounting of the dowel in the insulation material. This pre-fabrication of the reinforcement mat may be achieved by means of binders as for example resin without damaging the fiber structure. As fiber materials particularly tensile materials, as for example polymeric, mineral or glass containing materials (or mixtures thereof) are applied. The same applies for the materials of the second reinforcement mat respectively fabric layer 5 (not shown) which is applied at the end of the mounting process.

FIG. 2 shows the first embodiment of the first reinforcement mat respectively fabric layer 2 with the cylindrical depression respectively recess again from the side. The reinforcement mat comprises a side lengths L, which in the shown embodiment corresponds approximately to the double diameter D of the cylindrical depression respectively recess 6. Depending on the area of application and on the desired system bearing capacity also larger and smaller length ratios are possible. The diameter D of the depression respectively recess 6 corresponds approximately to the diameter of the pressing plate 4 of the applied dowel 3.

In FIGS. 3a and 3b a second embodiment of a first reinforcement mat respectively fabric layer 2 for use in an inventive fastening system is illustrated. This first reinforcement mat respectively fabric layer 2 comprises a circular ground plane and consists of concentrically and radially arranged grid lines 11, 12. The radial grid lines 12 thereby divide the concentrically arranged grid lines 11 into multiple segments 18. Also in this embodiment there is arranged a cylindrical depression respectively recess 6 in the middle of the first fabric layer 2. The cylindrical depression respectively recess 6 is preferably pre-fabricated again, in order to facilitate the mounting of the inventive fastening system for conventional pressing plate diameters and conventional mounting depths. One can see that the radial grid lines 12 may extend from the opening 9 to the outmost circle and also a bit further. Regularly the radial grid lines 12 divide the concentric circles 11 into twelve to twenty-four segments 18. The radial grid lines 12 may be formed somewhat stronger with respect to the concentric circles 11 in order to provide the utmost strength to the structure. Also here the sidewalls 16 of the cylindrical depression respectively recess 6 extend vertically downwards, whereby the latter are again followed by a horizontal bottom 17.

In FIG. 4 an inventive fastening system is illustrated in the mounted condition. As one can see, a first reinforcement mat respectively fabric layer 2 according to the second embodiment lies respectively rests onto the surface 7 of the insulation material 1 with concentric and radial grid lines 11, 12 in a ring-shaped 13 manner. The sidewall 16 of the cylindrical depression respectively recess 6 rests at the inner wall of the respective recess 6′ in the insulation material 1. The bottom 17 of the first reinforcement mat respectively fabric layer 2 is clamped between the pressing plate 4 of the dowel 3 being pulled into the insulation material 1 and the bottom of the depression in the insulation material. Above the pressing plate 4 of the dowel 3 only half of the circular member 8 is shown for reasons of clearness, by means of which the cylindrical depression respectively recess 6 is finally closed. The circular member usually consists of the same material as the insulation material 1 (i.e. for example of polystyrene, neopor, polyurethane or mineral wool etc.).

In FIG. 5 finally a third embodiment of a first reinforcement mat respectively fabric layer 2 is shown. This first reinforcement mat respectively fabric layer 2 is regularly formed square corresponding to the first embodiment of the first reinforcement mat respectively fabric layer 2 and comprises square grid lines 10. It further also comprises a centrally arranged opening 9 through which the shaft of a dowel 3 may be inserted. Unlike the embodiments described above, this first reinforcement mat respectively fabric layer 2 does not comprise a pre-fabricated cylindrical depression 6. The first reinforcement mat respectively fabric layer 2 may rather be mounted directly. In order to avoid that during pulling-in of the pressing plate 4 of the dowel 3 into the insulation material 1 and the resulting expansion of the reinforcement fabric no folds occur, four cuts 14 are provided which respectively extend from the corners of the reinforcement mat respectively fabric layer 2 to a marking 15, which may be printed respectively bonded onto the first reinforcement mat respectively fabric layer 2 in the factory. The marking 15 regularly corresponds approximately to the circumference of the pressing plates used for the mounting. The tensions occurring during the expansion of the reinforcement fabric may be compensated through the three spaces created in this manner, such that during mounting no waves or folds occur. This third embodiment of a first reinforcement mat respectively fabric layer 2 may also be used as second reinforcement mat respectively fabric layer 5 (not illustrated) by means of which the desired fabric overlapping respectively cross-linking is achieved in the area of the dowels. However, in this regard regularly standardized square reinforcement mats without pre-fabricated depressions (or marking) are used. Also round reinforcement mats with concentric circles without pre-fabricated depression (or marking) are conceivable. In a preferred embodiment of the invention respectively a square reinforcement mat is connected with a concentric reinforcement mat.

The process for deepened mounting of the dowel 3 in the insulation material 1 is as follows: (a) drilling a bore hole through the insulation material 1 and into a sub-construction; (b) cutting-in the insulation material 1 by means of a cutting device; (c) applying a first fabric layer 2 to the underside of the pressing plate 4; (d) inserting the dowel 3 into the bore hole until it rests on the insulation material surface 7; (e) driving in the spreading element by means of a mounting tool under compression of the insulation material 1 and formation of a cylindrical recess 6′ with predetermined depth in the insulation material (hereafter, if applicable also a circular member may be inserted into the recess 6 in order to close the latter); (f) reinforcing the entire insulation material surface 7 with a second fabric layer 5 (not shown), such that in the vicinity of the recess 6 a fabric overlapping under cross-linking of the individual fabric layers 2, 5 occurs. These steps may, but do not have to, occur in the specified order. In particular steps (a) to (e) may for example be carried out simultaneously. An alternative process for a deepened mounting of the dowel 3 in an insulation material 1 with pre-fabricated cylindrical recesses (not shown) is as follows: (a) drilling a bore hole into a recess through the insulation material 1 and into a sub-construction; (b) providing a first fabric layer 2 in the area of the recess; (c) inserting a dowel 3 through the first fabric layer 2 into the bore hole and the recess; (d) driving in the spreading element by means of a mounting tool; (e) reinforcement of the interior insulation material surface 7 with a second fabric layer 5, such that in the vicinity of the recess a fabric overlapping under cross-linking of the individual fabric layers 2, 5 occurs. These steps may, but do not have to, be carried out in the specified order. In particular for example steps (a) to (d) may be carried out simultaneously. The pre-fabricated recesses may be applied to the insulation material in the factory by means of milling, punching, thermal treatment etc. It is however also conceivable that the recesses are only created in situ (as an upstream method step). Further, the recesses may also be manufactured together with step (a), or subsequently (as a downstream method step). This may for example be achieved by means of a suitable milling device. The term “prefabricated” is to be understood in this context in such a way that the recess is at least created respectively milled before putting the dowel into the insulation material, i.e. either in the factory or in situ at the construction site (either before drilling, simultaneously with the drilling or after the drilling—however before applying the dowel).

It is the cross linking of two congeneric fabric layers in connection with the plaster shell which enables that significantly higher forces may be introduced into the dowel as before and therefore significantly higher dowel bearing capacities may be achieved as compared to the known solutions.

1. A method for deepened mounting of a dowel in an insulation material, wherein the dowel comprises a pressing plate and a dowel sleeve being attached thereto as well as a spreading element, wherein the method comprises the following steps;
(a) drilling a bore hole through the insulation material and into a sub-construction;
(b) cutting in the insulation material by means of a cutting device;
(c) applying a first fabric layer to the underside of the pressing plate;
(d) inserting the dowel into the bore hole until it rests onto the insulation material surface;
(e) driving in the spreading element by means of a mounting tool under compression of the insulation material and formation of a cylindrical recess with a predetermined depth in the insulation material;
(f) reinforcement of the entire insulation material surface with a second fabric layer such that in the vicinity of the recess a fabric overlapping under cross-linking of the individual fabric layers occurs.

2. The method according to claim 1, wherein after step (e) the cylindrical recess is closed by means of a corresponding circular member.

3. The method according to claim 1, wherein the first fabric layer comprises the shape of the cylindrical recess.

4. The method according to claim 3, wherein the respective shape is given to the first fabric layer by means of a binder.

5. The method according to claim 4, wherein as binder resins, synthetic resin dispersions or two-component reactive resins are used.

6. A fastening system for deepened mounting of a dowel comprising:
a compressable insulation material;
a dowel with a pressing plate;
a first fabric layer to be applied to the underside of a pressing plate; and
a second fabric layer for creating a fabric overlapping with the first fabric layer.

7. A fastening system according to claim 6, wherein the dowel may be mounted in a deepened manner in the insulation material under creation of a cylindrical recess in the insulation material such that the first fabric layer rests in the vicinity of the recess on the upper side of the insulation material.

8. A fastening system according to claim 7, wherein the first fabric layer rests at the inner wall of the cylindrical recess in the insulation material.

9. A fastening system according to claim 6, wherein the first fabric layer comprises the shape of the cylindrical recess.

10. A fastening system according to claim 9, wherein the first fabric layer is given the respective shape by means of a binder.

11. A fastening system according to claim 10, wherein as binder resins, synthetic resin dispersions or two-component reactive resins are used.

12. The method for deepen mounting of a dowel in an insulation material, wherein the dowel comprises a pressing plate and a dowel sleeve being attached thereto as well as a spreading element and wherein the insulation material comprises pre-fabricated cylindrical recesses for receiving the pressing plate, wherein the method comprises the following steps:
(a) drilling a bore hole into a recess through the insulation material and into a sub-construction;
(b) providing a first fabric layer in the area of the recess;
(c) inserting the dowel through the first fabric layer into the bore hole and into the recess;
(d) driving in the spreading element by means of a mounting tool;
(e) reinforcing the entire insulation material surface with a second fabric layer such that in the vicinity of the recess a fabric overlapping under cross-linking of the individual fabric layers occurs.

13. The method according to claim 12, wherein after step (d) the cylindrical recess is closed with a corresponding circular member.

14. The method according to claim 12, wherein the first fabric layer comprises the shape of the cylindrical recess.

15. The method according to claim 14, wherein the first fabric layer is given the respective shape by means of a binder.

16. The method according to claim 15, wherein as binder resins, synthetic resin dispersions or two-component reactive resins are used.

17. A fastening system for deepened mounting of a dowel comprising:
an insulation material with pre-fabricated cylindrical recesses;
a dowel with a pressing plate;
a first fabric layer to be applied to the underside of the pressing plate; and
a second fabric layer for creating a fabric overlapping with the first fabric layer.

18. A fastening system according to claim 17, characterized in that the first fabric layer rests in the mounted condition in the vicinity of a cylindrical recess onto the upper side of the insulation material.

19. A fastening system according to claim 18, characterized in that the first fabric layer rests at the inner wall of the cylindrical recess in the insulation material.

20. A fastening system according to claim 17, wherein the first fabric layer comprises the shape of the cylindrical recess.

21. A fastening system according to claim 20, characterized in that the first fabric layer is given the respective shape by means of a binder.

22. A fastening system according to claim 21, characterized in that as binder resins, synthetic resin dispersions or two-component reactive resins are used.
